(19) United States
(12) Patent Application Publication
(10) Pub. No.: US 2009/0049952 A1
(43) Pub. Date: Feb. 26, 2009

(54) Starter having intermediate gear

(75) Inventor: Masao Saitoh, Okazaki-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 12/230,074

(22) Filed: Aug. 22, 2008

(30) Foreign Application Priority Data
Aug. 24, 2007 (JP) 2007-218915

(51) Int. Cl. F02N 15/06

(52) U.S. Cl. 74/7 C

(57) ABSTRACT

A starter having intermediate gear includes a clutch, a pinion, an intermediate gear and a link member. The pinion has a boss portion formed with a pair of pinion flanges. The intermediate gear has a boss portion formed with a pair of intermediate gear flanges. The upper end side of the link member is engaged with a groove between the pair of pinion flanges, being in contact with the pinion flanges. The lower end side of the link member is engaged with a groove between the pair of intermediate gear flanges, being in contact with the intermediate gear flanges. Thus, unlike the conventional art, no influence is caused by the axial dimensional variations and position of the clutch. As a result, the axial rattling of the Intermediate gear can be suppressed, and no substantial design change is necessary to cope with the positional change of the clutch.

### CROSS-REFERENCE TO RELATED APPLICATION

This application is based on and claims the benefit of priority from earlier Japanese Patent Application No. 2007-218915 filed Aug. 24, 2007, the description of which is Incorporated herein by reference.

### BACKGROUND OF THE INVENTION

1. Technical field of the Invention

The present invention relates to a starter having intermediate gear, for starting an engine through an intermediate gear that is engaged with a pinion and rotated by the torque of the pinion.

2. Related Art

A starter having intermediate gear is disclosed, for example, in Japanese Patent Application Laid-Open Publication No. 2002-180937. The starter having intermediate gear disclosed in this literature is provided with a clutch, a pinion, an intermediate gear and a link member. The link member has a function of limiting axial relative movement between the pinion and the intermediate gear. One end side of the link member is disposed between the pinion and the clutch, being engaged with a pinion boss portion provided at the pinion so as to be relatively rotatable. The other end side of the link member is engaged with a cylindrical boss portion provided at the intermediate gear so as to be relatively rotatable. The integral movement of the clutch and the pinion in the axial direction permits the intermediate gear to move in the axial direction via the link member, for engagement with a ring gear of the engine to thereby start the engine.

Generally, clutches are structured by combining a plurality of members. This means that the dimensional variations of such members may be accumulated to cause difficulty in suppressing the dimensional variations as a clutch. Thus, larger dimensional variations in the axial direction of a clutch may cause larger rattling of the link member in the axial direction. Accordingly, it has been a problem that axial rattling may also be increased in the intermediate gear.

Also, there may be a case where a space is desired to be ensured in a starter in an on-vehicle state, in order to avoid interference between the clutch and other members. To this end, the clutch may be arranged on a rear side, while the pinion and the intermediate gear are permitted to remain at the same positions. This, however, may involve an increase in the dimension between the pinion and the clutch, necessitating the link member to have a larger thickness. Accordingly, this may also involve the change in the shape of the cylindrical boss portion of the intermediate gear engaged with the link member. Thus, a substantial design change may be necessary, raising another problem of difficulty in suppressing the cost.

### SUMMARY OF THE INVENTION

The present Invention has been made in light of the circumstances provided above, and has as its object to provide a starter having intermediate gear, which is able to suppress the axial rattling of the intermediate gear and cope with the change in the arrangement position of the clutch, without involving a substantial design change.

In order to resolve the problems, the inventor of the present invention has devoted to researches through much practical experimentation. As a result, the inventor has made an invention which provides a pair of pinion flanges to a pinion boss portion, and brings one end side of a link member into contact with a groove formed between the pair of pinion flanges for engagement, so that the axial rattling of the intermediate gear can be suppressed and that no substantial design change may be required in changing the arrangement position of the clutch.

Specifically, the starter having intermediate gear according to a first aspect, a starter having intermediate gear comprises an output shaft configured to output torque of a motor; a clutch provided at the output shaft so as to be axially movable, and configured to transmit the torque of the output shaft; a pinion having a pinion boss portion and provided at the output shaft so as to be axially movable and relatively rotatable, one axial end surface of the pinion boss portion being connected to the clutch, so that the pinion can be rotated upon transmission of the torque from the output shaft via the clutch; an intermediate shaft disposed parallel to the output shaft; an intermediate gear having an intermediate gear boss portion and provided at the intermediate shaft so as to be axially movable and relatively rotatable, the intermediate gear being engaged with the pinion and rotated by the torque of the pinion; and a link member configured to engage with the pinion boss portion and the intermediate gear boss portion so as to be relatively rotatable and to limit axial relative movement of the pinion and the intermediate gear, and permitting the clutch and the pinion to integrally move in the axial direction to move the intermediate gear in the axial direction via the link member and to engage with a ring gear of an engine, so that the engine can be started, wherein: the pinion comprises a pair of pinion flanges provided at an outer peripheral surface of the pinion boss portion so as to be opposed to each other in an axial direction; the intermediate gear comprises a pair of intermediate gear flanges provided at an outer peripheral surface of the intermediate gear boss portion so as to be opposed to each other in the axial direction; and the link member has one end side which is engaged with a groove formed between the pair of pinion flanges in a state of being in contact with the pair of pinion flanges, and has the other end side which is engaged with a groove formed between the pair of intermediate gear flanges in a state of being in contact with the pair of intermediate gear flanges.

According to this configuration, a pair of pinion flanges is provided in the pinion boss portion. The link member is engaged with the groove formed between the pair of pinion flanges, in the state of being in contact with the pinion flanges. Thus, the axial rattling of the link member can be suppressed, without being influenced by the axial dimensional variations of the clutch. As a result, the axial rattling of the intermediate gear can be suppressed. Further, as described above, the link member is engaged with the groove formed between the pair of pinion flanges. Thus, the positional change of the clutch only necessitates the change in the axial lengths of the output shaft and the pinion boss portion, and does not necessitate the change of the link member and the intermediate gear boss portion. In this way, the positional change of the clutch can be dealt with, without involving substantial design change.

In the starter having intermediate gear according to a second aspect, the pinion flange on the side of the clutch has an end surface in contact with the link member, the end surface having an outermost diameter smaller than an outermost diameter of a pinion-side end surface of the clutch.

In the starter having intermediate gear according to a third aspect, the pinion flange on the side of the clutch has an outer peripheral surface which is provided with a foreign matter entry prevention member having an annular shape, and is configured to prevent entry of foreign matters from the side of the pinion Into the side of the clutch.

In the starter having intermediate gear according to a fourth aspect, the foreign matter entry prevention member has a gap between the foreign matter entry prevention member and the link member.

In the starter having intermediate gear according to a fifth aspect, the clutch comprises a cylindrical clutch outer which is provided at the output shaft so as to be axially movable and relatively unrotatable; a cylindrical clutch inner which is provided at the output shaft so as to be coaxially located inside the clutch outer, and to be axially movable and relatively rotatable, axial one end surface of the clutch inner being connected to the pinion boss portion; a columnar clutch roller arranged between an inner peripheral surface of the clutch outer and an outer peripheral surface of the clutch inner; a washer arranged on an opening end side of the clutch outer and configured to limit axial movement of the clutch roller; and a bottomed cylindrical clutch cover having a bottom portion which is provided with a through hole having an inner diameter larger than an outermost diameter of the pinion, the clutch cover being configured to cover the opening end side of the clutch outer in a state where the clutch inner is inserted into the through hole, and to fix the washer to the clutch outer.

### BRIEF DESCRIPTION OF THE DRAWINGS

In the accompanying drawings:

FIG. 1 is a partial cross-sectional view illustrating a starter having intermediate gear, according to an embodiment of the present invention;

FIG. 2 is a partially enlarged cross-sectional view illustrating so the pinion and the perimeter of the intermediate gear illustrated In FIG. 1; and

FIG. 3 is a front elevational view of a link member.

### DETAILED DESCRIPTION OF THE PREFERRED EMBODIMENTS

With reference to the accompanying drawings, an embodiment of the present invention will now be described in detail.

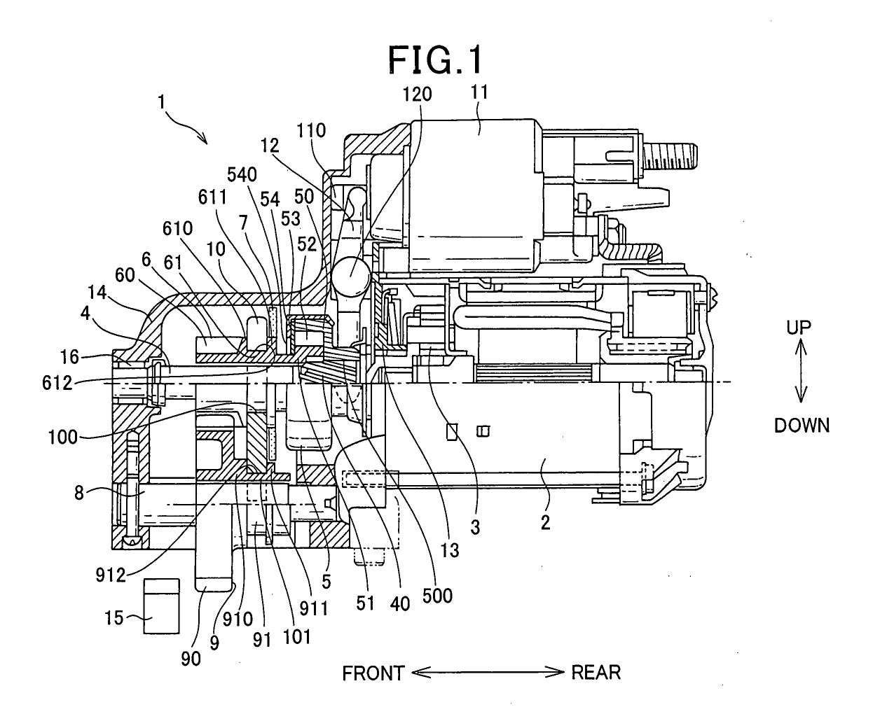

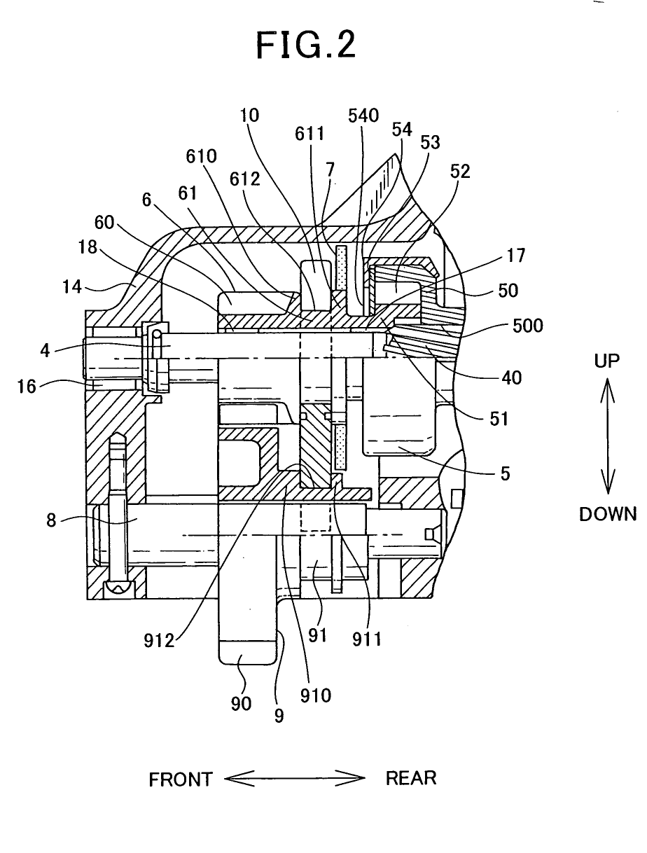

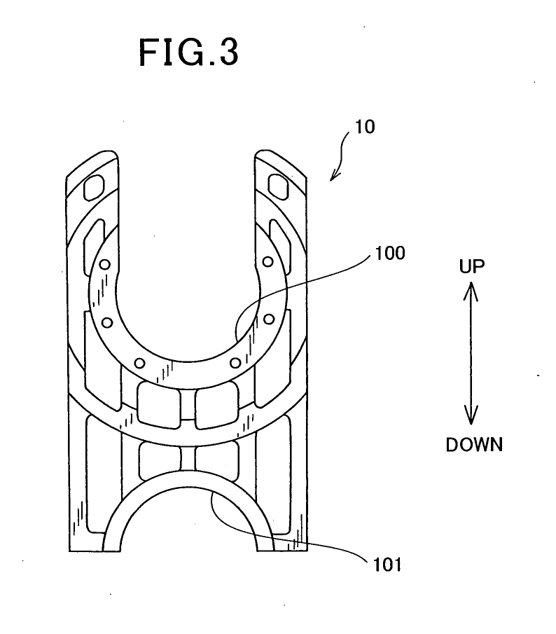

Referring to FIGS. 1 to 3, an explanation is given on the configuration of a starter having intermediate gear. FIG. 1 is a partial cross-sectional view illustrating the starter having intermediate gear according to the present embodiment. FIG. 2 is a partially enlarged cross-sectional view illustrating the pinion and the perimeter of the intermediate gear illustrated in FIG. 1. FIG. 3 is a front elevational view of a link member. It should be appreciated that the front-rear direction and the up-down direction are indicated in each of the figures for the sake of convenience in distinguishing directions.

As shown in FIG. 1, a starter 1 having an intermediate gear (hereinafter just referred to as “starter 1”) includes a motor 2, a reduction device 3, an output shaft 4, a clutch 5, a pinion 6, a foreign matter entry prevention member 7, an intermediate shaft 8, an intermediate gear 9, a link member 10, an electromagnetic switch 11 and a shift lever 12.

The motor 2 generates torque for starting an engine (not shown), or specifically, the motor 2 is a DC motor. The reduction device 3 reduces torque of the motor 2, for transmission to the output shaft 4, or specifically, the reduction device 3 is a planetary reduction gear system. The reduction device 3 is fixed to a center case 13. The motor 2 is disposed behind the reduction device 3 and fixed to the center case 13. The motor 2 and the reduction device 3 are fixed to a rear end portion of a housing 14, together with the center case 13.

The output shaft 4 is a substantially cylindrical metal member for outputting torque of the motor 2 whose speed has been reduced by the reduction device 3. A helical spline 40 is formed in the outer peripheral surface of the axially intermediate portion of the output shaft 4. The output shaft 4, whose rear end portion is fixed to the reduction device 3, is rotatably supported by the housing 14 via a bearing 16.

The clutch 5 is provided at the output shaft 4 so as to be axially movable. Being pressed by the shift lever 12, the clutch 5 is allowed to move in the axial direction to transmit torque of the output shaft 4 to the pinion 6. When the speed of the output pinion 6 exceeds that of the output shaft 4, the clutch 5 idles to cut off the transmission of torque. As shown in FIG. 2, the clutch 5 includes a clutch outer 50, a clutch inner 51, a clutch roller 52, a washer 53 and a clutch cover 54.

The clutch outer 50 is a substantially cylindrical member made of metal, which is provided so as to be axially movable but relatively unrotatable. The clutch outer 50 has an inner peripheral surface in which a helical spline 500 is formed on the rear end side. The clutch outer 50 is disposed in a state where the helical spline 500 is engaged to the helical spline 40 of the output shaft 4. Thus, the output shaft 4 so as to be axially movable but unrotatable supports the clutch outer 50.

The clutch inner 51 is a substantially cylindrical member made of metal and is provided at the output shaft 4 so as to be coaxially located inside the clutch outer 50, and to be axially movable and relatively rotatable. The clutch inner 51 has a front-end surface connected to a boss portion 61 of the pinion 6, which will be described later. The clutch inner 51 is supported by the output shaft 4 via a bearing 17 so as to be axially movable and relatively rotatable.

The clutch roller 52 is a cylindrical member made of metal and is arranged between the inner peripheral surface of the clutch outer 50 and the outer peripheral surface of the clutch inner 51 to mechanically couple the clutch outer 50 and the clutch inner 51. The clutch roller 52 is disposed in a space defined by the inner peripheral surface of the clutch outer 50 and the outer peripheral surface of the clutch inner 51 so as to be movable along the circumference.

The washer 53 is an annular plate-like member made of metal for limiting the axial movement of the clutch roller 52 against the clutch outer 50. The washer 53 is arranged on the side of the front opening end of the clutch outer 50. Specifically, the washer 53 is disposed so that its outer peripheral side is in contact with the front-end surface of the clutch outer 50, and its inner peripheral side is in contact with the front-end surface of the clutch roller 52.

The clutch cover 54 is a bottomed cylindrical plate-like member made of metal and has a through hole 540 in the bottom portion thereof. The clutch cover 54 covers the opening end side of the clutch outer 50, while allowing insertion of the clutch inner 51 through the through hole 540, and fixes the washer 53 to the clutch outer 50. The inner diameter of the through hole 540 is set larger than the outermost diameter of the pinion 6.

The pinion 6 is a substantially cylindrical member made of metal and is provided at the output shaft 4 so as to be axially movable and relatively rotatable. The pinion 6 is adapted to rotate when the torque of the output shaft 4 is transmitted thereto via the clutch 5. The pinion 6 is made up of a tooth portion 60 and the boss portion 61 (pinion boss portion). The tooth portion 60 is a substantially cylindrical portion that engages with the intermediate gear 9. The boss portion 61 is a cylindrical portion that is formed so as to be coaxial with the rear end surface of the tooth portion 60. A pair of annular flanges 610 and 611 is formed in the outer peripheral surface of the boss portion 61 so as to be opposed to each other in the axial direction. The outer diameter of each of the flanges 610 and 611 is set smaller than that of the clutch 5, or that of the clutch cover 54. The axial dimension of a groove 612 formed between the flanges 610 and 611 is set slightly larger than that of the link member 10 engaged with the groove. The rear end surface of the boss portion 61 is linked to the front-end surface of the clutch inner 51. The pinion 6 is supported by the output shaft 4 via a bearing 18 so as to be axially movable and relatively rotatable.

The foreign matter entry prevention member 7 is an annular plate-like member made of rubber, which is adapted to prevent entry of foreign matters, such as dust and water droplets, from the side of the pinion 6 into the side of the clutch 5. The foreign matter entry prevention member 7 is coaxially fixed to the flange 611 of the pinion 6. The axial dimension of the foreign matter entry prevention member 7 is set so that a gap can be formed between the member 7 and the link member 10.

The intermediate shaft 8 is a columnar member made of metal and is disposed parallel to the output shaft 4. Both ends of the intermediate shaft 8 are fixed to the housing 14.

The intermediate gear 9 is a substantially cylindrical member made of metal and is provided at the intermediate shaft 8 so as to be axially movable and relatively rotatable. The intermediate gear 9 is engaged with the pinion 6 and rotated by the torque of the pinion 6. The intermediate gear 9 is made up of a tooth portion 90 and a boss portion 91 (intermediate gear boss portion). The tooth portion 90 is a substantially cylindrical portion that is engaged with the tooth portion 60 of the pinion 6. The boss portion 91 is a cylindrical portion coaxially formed in the rear end surface of the tooth portion 90. The boss portion 91 has an outer peripheral surface in which a pair of annular flanges 910 and 911 is formed so as to be opposed to each other in the axial direction. The axial dimension of a groove 912 formed between the flanges 910 and 911 is set slightly larger than that of the link member 10 engaged with the groove.

The link member 10 is a substantially rectangular plate-like member made of metal or resin and is engaged with both of the boss portion 61 of the pinion 6 and the boss portion 91 of the intermediate gear 9 so as to be relatively rotatable. The link member 10 limits the relative movement of the pinion 6 and the intermediate gear 9 in the axial direction. As shown in FIG. 3, the upper end of the link member 10 is provided with a semi-ellipsoidal notch 100 to be engaged with the boss portion 61 of the pinion 6. The lower end of the link member 10 is also provided with a semi-circular notch 101 to be engaged with the boss portion 91 of the intermediate gear 9. As shown in FIG. 2, the upper end of the link member 10 is engaged with the groove 612 in the state where the front and rear end surfaces near the notch 100 in the member 10 are in contact with the flanges 610 and 611, respectively. The lower end of the link member 10 is also engaged with the groove 912 in the state where the front and rear end surfaces near the notch 101 in the member 10 are in contact with the flanges 910 and 911, respectively.

As shown in FIG. 1, the electromagnetic switch 11 generates drive power for swinging the shift lever 12, and supplies DC current to the motor 2 via a contact point (not shown). The electromagnetic switch 11 is provided with a plunger 110 that reciprocates in the axial direction by the magnetic force, and is fixed to the rear end portion of the housing 14.

The shift lever 12 is swingably supported by the housing 14 by means of a pin 120, in the state where the upper end portion of the shift lever is engaged with the plunger 110 and the lower end portion of the shift lever is engaged with the clutch outer 50. The shift lever 12 is adapted to swingably move about the pin 120 with the drive power generated by the electromagnetic switch 11, so that the clutch 5 is pressed and moved in the axial direction.

Referring now to FIG. 1, an explanation is given on the operation of the starter having intermediate gear. In FIG. 1, when an ignition switch (not shown) is switched on, power is supplied to the electromagnetic switch 11 to have the coils (not shown) generated magnetic force, by which the plunger 110 is moved rearward. With the movement of the plunger 110, the shift lever 12 swings so that the clutch 5 and the pinion 6 are integrally moved forward. The forward movement of the pinion 6 permits the intermediate gear 9 to move forward, as well, via the link member 10, for engagement with a ring gear 15 of the engine. In this case, the contact point of the electromagnetic switch 11 is closed to supply DC power to the motor 2. Thus, the motor 2 generates the torque for starting the engine, and the torque generated by the motor 2 is then reduced by the reduction device 3 and transmitted to the output shaft 4. Then, the torque is transmitted from the clutch 5 through the pinion 6 to the intermediate gear 9, and then through the ring gear 15 to the engine to thereby start the engine.

When the engine is started and the ignition switch is turned off, the power supply to the electromagnetic switch 11 is shut off. Then, the magnetic force generated in the coils is eliminated, whereby the plunger 110 is permitted to move forward by the force of a return spring (not shown) for example. With the movement of the plunger 110, the shift lever 12 swings, so that the clutch 5 and the pinion 6 are integrally moved rearward. The rearward movement of the pinion 6 permits the intermediate gear 9 to move rearward, as well, via the link member 10, for disengagement from the ring gear 15. In this case, the contact point of the electromagnetic switch 11 is opened to shut off the DC power supply to the motor 2. Then, the motor 2 is stopped to complete starting the engine.

Finally, an explanation is given on the advantages. According to the present embodiment, the boss portion 61 of the pinion 6 is provided with the flanges 610 and 611. The link member 10 is engaged with the groove 612 formed between the flanges 610 and 611 in the state of being in contact with the flanges 610 and 611. Thus, unlike the conventional art, the axial rattling of the link member 10 can be suppressed without being influenced by the axial dimensional variations of the clutch 5. Also, there may be a case where a space is desired to be ensured in a starter in an on-vehicle state, in order to avoid interference between the clutch and other members. To this end, the motor 2, the reduction device 3, the clutch 5 and the electromagnetic switch 11 may be arranged on a rear side, while the pinion 6 and the intermediate gear 9 are permitted to remain at the same positions. In this regard, since the link member 10 is engaged with the groove 612 as described above, only the increase in the axial lengths of the output shaft 4 and the boss portion 61 of the pinion 6 can ensure such a space, without the necessity of the positional and/or dimensional changes in the link member 10 and the boss portion 91 of the intermediate gear 9. In this way, the positional changes of the clutch 5 and the like can be dealt with, without involving a substantial design change.

According to the present embodiment, the outer diameter of the flange 611 is set smaller than that of the clutch cover 54. Thus, upon rotation of the pinion 6, the flange 611 slidably comes into contact with the link member 10. The smaller setting of the outer diameter of the flange 611 than that of the clutch cover 54, can reduce the slidable contact area between the flange 611 and the link member 10, comparing with the conventional art in which the slidable contact area has been made between the end surface of the clutch on the side of the pinion and the link member. In addition, since the flange 611 has a smaller diameter, the speed at the time of the sliding contact can be suppressed. Accordingly, the abrasion accompanying the sliding contact can also be suppressed between the flange 611 and the link member 10.

Further, according to the present embodiment, owing to the fixation of the foreign matter entry prevention member 7 to the outer peripheral surface of the flange 611, foreign matters, such as dust and water droplets, can be prevented from entering into the side of the clutch 5 from the side of the pinion 6. Also, since a gap is provided between the foreign matter entry prevention member 7 and the link member 10, the rotation of the pinion 6 may not cause the prevention member 7 to come into slidable contact with the link member 10. Accordingly, the abrasion that would accompany the rotation can be prevented from occurring between the foreign matter entry prevention member 7 and the link member 10.

Additionally, according to the present embodiment, the pinion 6 is linked to the clutch inner 51, while the clutch cover 54 is provided with the through hole 540 for inserting the clutch inner 51. In addition, the inner diameter of the through hole 540 is set larger than the outermost diameter of the pinion 6, or is set larger than the outer diameter of the tooth portion 60 as well as the outer diameters of the flanges 610 and 611. Thus, the pinion 6 can be inserted into the through hole 540 after assembling the clutch outer 50, the clutch inner 51, the clutch roller 52 and the washer 53, which can then be followed by assembling the clutch cover 54. In this way, the assembling properties can be enhanced.

What is claimed is:

1. A starter having intermediate gear comprising:
an output shaft configured to output torque of a motor;
a clutch provided at the output shaft so as to be axially movable, and configured to transmit the torque of the output shaft;
a pinion having a pinion boss portion and provided at the output shaft so as to be axially movable and relatively rotatable, one axial end surface of the pinion boss portion being connected to the clutch, so that the pinion can be rotated upon transmission of the torque from the output shaft via the clutch;
an intermediate shaft disposed parallel to the output shaft;
an intermediate gear having an intermediate gear boss portion and provided at the intermediate shaft so as to be axially movable and relatively rotatable, the intermediate gear being engaged with the pinion and rotated by the torque of the pinion; and
a link member configured to engage with the pinion boss portion and the intermediate gear boss portion so as to be relatively rotatable and to limit axial relative movement of the pinion and the intermediate gear, and
permitting the clutch and the pinion to integrally move in the axial direction to move the intermediate gear in the axial direction via the link member and to engage with a ring gear of an engine, so that the engine can be started, wherein:
the pinion comprises a pair of pinion flanges provided at an outer peripheral surface of the pinion boss portion so as to be opposed to each other in an axial direction;
the intermediate gear comprises a pair of intermediate gear flanges provided at an outer peripheral surface of the intermediate gear boss portion so as to be opposed to each other in the axial direction; and
the link member has one end side which is engaged with a groove formed between the pair of pinion flanges in a state of being in contact with the pair of pinion flanges, and has the other end side which is engaged with a groove formed between the pair of intermediate gear flanges in a state of being in contact with the pair of intermediate gear flanges.

2. The starter having intermediate gear according to claim 1, wherein the pinion flange on the side of the clutch has an end surface in contact with the link member, the end surface having an outermost diameter smaller than an outermost diameter of a pinion-side end surface of the clutch.

3. The starter having intermediate gear according to claim 1, wherein the pinion flange on the side of the clutch has an outer peripheral surface which is provided with a foreign matter entry prevention member having an annular shape, and is configured to prevent entry of foreign matters from the side of the pinion Into the side of the clutch.

4. The starter having intermediate gear according to claim 3, wherein the foreign matter entry prevention member has a gap between the foreign matter entry prevention member and the link member.

5. The starter having intermediate gear according to claim 1, wherein the clutch comprises:
a cylindrical clutch outer that is provided at the output shaft so as to be axially movable and relatively unrotatable;
a cylindrical clutch inner which is provided at the output shaft so as to be coaxially located inside the clutch outer, and to be axially movable and relatively rotatable, axial one end surface of the clutch inner being connected to the pinion boss portion;
a columnar clutch roller arranged between an inner peripheral surface of the clutch outer and an outer peripheral surface of the clutch inner;
a washer arranged on an opening end side of the clutch outer and configured to limit axial movement of the clutch roller; and
a bottomed cylindrical clutch cover having a bottom portion which is provided with a through hole having an inner diameter larger than an outermost diameter of the pinion, the clutch cover being configured to cover the opening end side of the clutch outer in a state where the clutch inner is inserted into the through hole, and to fix the washer to the clutch outer.
